(19) United States
(12) Patent Application Publication
(10) Pub. No.: US 2014/0161128 A1
(43) Pub. Date: Jun. 12, 2014

(54) METHOD OF COMMUNICATING ACROSS DIFFERENT DOMAINS AND NETWORK APPARATUS

(71) Applicant: Huawei Technologies Co., Ltd., Shenzhen (CN)

(72) Inventors: Dhruv Dhody, Bangalore (IN); Udayasree Palle, Bangalore (IN); Quintin Zhao, Acton, MA (US)

(73) Assignee: Huawei Technologies Co., Ltd., Shenzhen (CN)

(21) Appl. No.: 14/167,315

(22) Filed: Jan. 29, 2014

Related U.S. Application Data
(63) Continuation of application No. PCT/CN2012/080236, filed on Aug. 16, 2012.

(30) Foreign Application Priority Data
Aug. 16, 2011 (IN) IN2326/DEL/2011

(51) Int. Cl. H04L 12/741

(52) U.S. Cl. CPC H04L 45/74
USPC 370/392

(57) ABSTRACT

The embodiments of the present disclosure provide a method of communicating across different domains and network apparatus. In the method, sending a Path Computation Request message to a Path Computation Element; wherein the Path Computation Request message includes an Include Route Object, and the Include Route Object is configured to specify a domain sequence; wherein the Include Route Object includes at least two sub-objects, and the at least two sub-objects identified the different domains. Through the embodiments of the present disclosure, standard way of representation for domain sequence has been implemented by using sub-object for area.

### CROSS-REFERENCE TO RELATED APPLICATIONS

This application is a continuation of International Application No. PCT/CN2012/080236, filed on Aug. 16, 2012, which claims priority to Indian Patent Application No. IN2326/DEL/2011, filed on Aug. 16, 2011, both of which are hereby incorporated by reference in their entireties.

### TECHNICAL FIELD

This application relates to Traffic Engineering (TE) and in particular, to a method of communicating across different domains and network apparatus.

### BACKGROUND ART

In Traffic Engineering (TE) networks, such as Multiprotocol Label Switching (MPLS) networks and Generalized MPLS networks, a Label Switched Path (LSP) can be established with a path provided by a Path Computation Client (PCC) and a Path Computation Element (PCE).

Specifically, the PCC requests a path or route from the PCE, which computes the path and forwards the computed path information back to the PCC. Path Computation Element Protocol (PCEP) is such a protocol designed specifically for communications between a PCC and PCE, or between two PCEs. a PCC may use PCEP to send a path computation request to a PCE, and the PCE may reply with a set of computed paths if one or more paths can be found that satisfies the set of constraints.

On the other hand, a domain is any collection of network elements within a common sphere of address management or path computation responsibility. Examples of domains include Interior Gateway Protocol (IGP) areas or Autonomous System (AS). To uniquely identify a domain, a sequence of the domain is important.

However, the applicant found that there is no standard way of representation for domain sequence. The sequence of domains to be traversed is administratively predetermined in the prior art, and there are some interoperability issues among different implementations of PCEP.

[Reference 1] “Path Computation Element (PCE) Communication Protocol (PCEP)” , RFC 5440.

[Reference 2] “A Backward-Recursive PCE-Based Computation (BRPC) Procedure to Compute Shortest Constrained Inter-Domain Traffic Engineering Label Awitched Paths”, RFC 5441.

### SUMMARY

Embodiments of the present disclosure pertain to a method of communicating across different domains and network apparatus. The aim is to have a standard representation that all implementations can follow during configuration of domain sequence.

According a first aspect of the embodiments of the present disclosure, there is provided a method of communicating across different domains, the method including:
sending a Path Computation Request message to a Path Computation Element; wherein the Path Computation Request message includes an Include Route Object, and the Include Route Object is configured to specify a domain sequence;
wherein the Include Route Object includes at least two sub-objects, and the at least two sub-objects identify the different domains.

According a second aspect of the embodiments of the present disclosure, there is provided a method of communicating across different domains, the method including:
receiving a Path Computation Request message; wherein the Path Computation Request message includes an Include Route Object, and the Include Route Object is configured to specify a domain sequence;
wherein the Include Route Object includes at least two sub-objects, and the at least two sub-objects identify the different domains.

According a third aspect of the embodiments of the present disclosure, there is provided a network apparatus, the network apparatus including:
a first sender to send a Path Computation Request message to a Path Computation Element; wherein the Path Computation Request message includes an Include Route Object, and the Include Route Object is configured to specify a domain sequence;
wherein the Include Route Object includes at least two sub-objects, and the at least two sub-objects identify the different domains.

According a fourth aspect of the embodiments of the present disclosure, there is provided a network apparatus, the network apparatus including:
a second receiver to receive a Path Computation Request message; wherein the Path Computation Request message includes an Include Route Object, and the Include Route Object is configured to specify a domain sequence;
wherein the Include Route Object includes at least two sub-objects, and the at least two sub-objects identify the different domains.

According a fifth aspect of the embodiments of the present disclosure, there is provided a computer-readable program, wherein when the program is executed in a network apparatus, the program enables the computer to carry out the method of communicating across different domains.

According a sixth aspect of the embodiments of the present disclosure, there is provided a storage medium in which a computer-readable program is stored, wherein the computer-readable program enables the computer to carry out the method of communicating across different domains.

The advantages of the present disclosure exist in that standard way of representation for domain sequence has been implemented by using sub-object for area, and interoperability issues among different domains will be resolved.

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated in size, e.g., made larger in relation to other parts than in an exemplary device actually made according to the disclosure. Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. The same element is represented with the same reference number throughout the drawings.

In the drawings:

FIG. 1 is a sequence diagram showing communication between a PCC and a PCE.

FIG. 2 is flowchart of the method of an embodiment of the present disclosure.

FIG. 3 is a topology diagram showing only AS of an embodiment of the present disclosure.

FIG. 4(A) and FIG. 4(B) are schematic diagrams of IRO in topology as shown in FIG. 3.

FIG. 5 is a topology diagram showing only area of an embodiment of the present disclosure.

FIG. 6(A) and FIG. 6(B) are schematic diagrams of IRO in topology as shown in FIG. 5.

FIG. 7 is a topology diagram showing mix of AS and area of an embodiment of the present disclosure.

FIG. 8 is schematic diagram of IRO in topology as shown in FIG. 7.

FIG. 9 is a topology diagram showing HPCE of an embodiment of the present disclosure.

FIG. 10(A) and FIG. 10(B) are schematic diagrams of ERO in topology as shown in FIG. 9.

FIG. 11 is flowchart of the method of an embodiment of the present disclosure.

FIG. 12 is a schematic diagram of the network apparatus of an embodiment of the present disclosure.

FIG. 13 is a schematic diagram of the network apparatus of another embodiment of the present disclosure.

### DETAILED DESCRIPTION OF THE DISCLOSURE

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

In the present application, embodiments of the disclosure are described primarily in the context of a router. However, it shall be appreciated that the disclosure is not limited to the context of a router and may relate to any type of appropriate electronic apparatus having the function of routers.

The preferred embodiments of the present disclosure are described as follows in reference to the drawings.

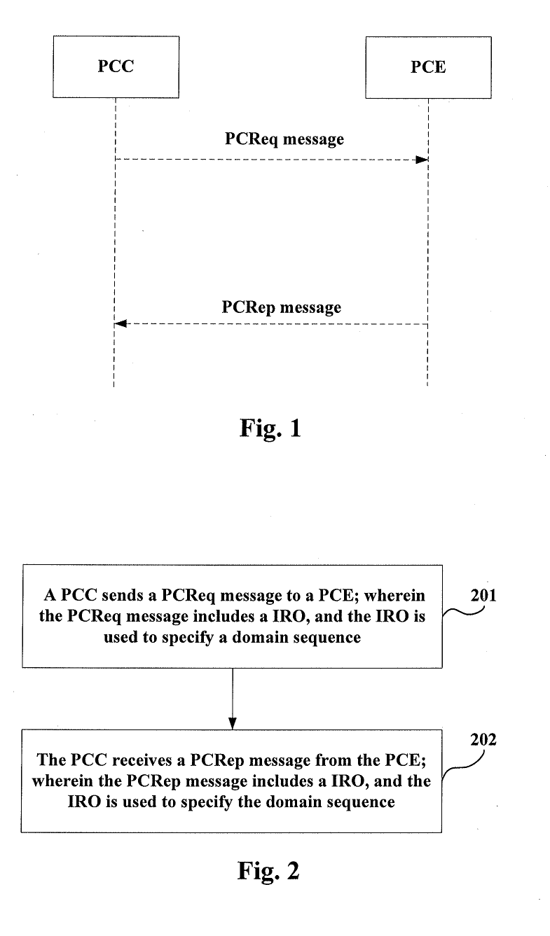

According to [reference 1], the Path Computation Element Protocol (PCEP) for communication is between a PCC and a PCE, or between two PCEs. FIG. 1 is a sequence diagram showing communication between a PCC and a PCE. For example, as shown in FIG. 1, a PCC sends a Path Computation Request (PCReq) message to a PCE, and the PCE computes paths, and may replies a Path Computation Reply (PCRep) message to the PCC.

The embodiments of the present disclosure provide a method of communicating across different domains, the method applied for a PCC or a PCE. A PCC will be illustrated as an example in this scenario, but it is not limited thereto, it may also be a PCE.

FIG. 2 is flowchart of the method of an embodiment of the present disclosure. As shown in FIG. 2, the method includes:
Step 201, a PCC sends a PCReq message to a PCE; the PCReq message includes a Include Route Object (IRO), the IRO is configured to specify a domain sequence;
wherein the IRO includes at least two sub-objects, and the at least two sub-objects are identified the different domains.

As shown in FIG. 2, the method may further include:
Step 202, the PCC receives a PCRep message from the PCE; wherein the PCRep message includes a IRO, the IRO is configured to specify the domain sequence.

In the present application, the IRO is configured to specify the domain sequence that the computed inter-domain path must traverse. As shown in [reference 1], IRO object-class is 10 and object-type is 1, and IRO is made of sub-objects.

As shown in [reference 1], the following sub-object types are supported for IRO:

| Type | Sub-Object |
|---|---|
| 1 | IPv4 prefix |
| 2 | IPv6 prefix |
| 4 | Unnumbered Interface ID |
| 32 | Autonomous System number |

In the present application, new sub-objects are used to represent domain sequence, and the sub-object includes an Area-Id.

In the present application, different sub-objects are proposed since the length of Area-Id is different for Open Shortest Path First (OSPF) and Intermediate System-Intermediate System (ISIS). The number of type for new sub-objects will be assigned by IANA, and it is out of the present application.

In an embodiment of the present disclosure, the Area-Id is a 32 bit number for OSPF, and the length of the sub-object is fixed. The sub-object looks like:

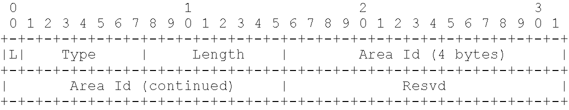

In another embodiment of the present disclosure, the Area-Id is of variable length for ISIS, and thus the length of the sub-object is variable. The Area-Id is as described in ISIS by ISO standard, and refer to the prior art, which shall not be described any further.

In an embodiment of the present disclosure, after received the PCRep message from the PCE (Step 202), the method further includes: the PCC acquires the domain sequence according to the IRO.

In one deployment scenario, there are only Autonomous Systems. Each AS is made of a single area and the area may be skipped in the domain sequence. So the domain sequence could be represented with just AS number.

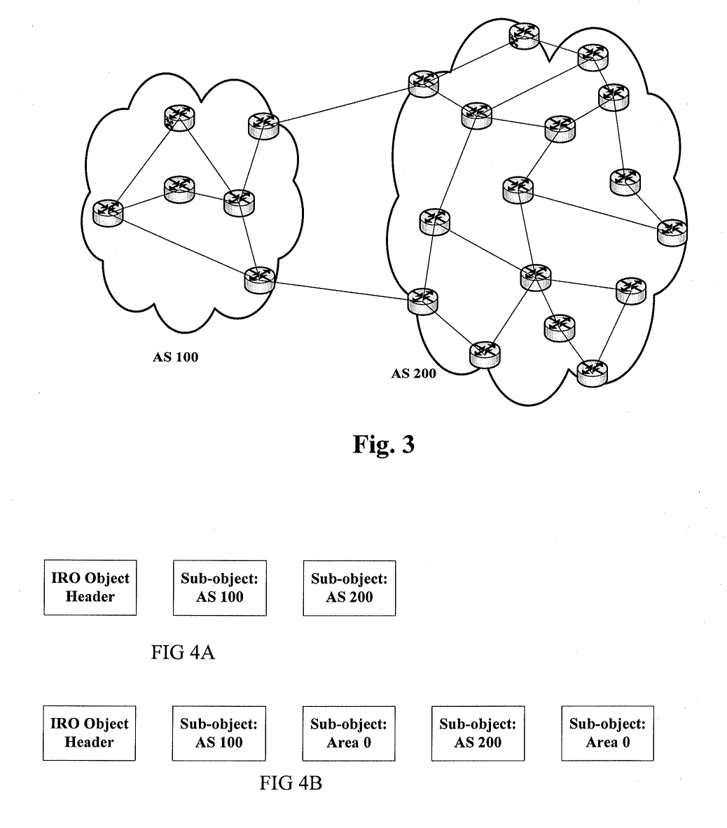

FIG. 3 is a topology diagram showing only AS of an embodiment of the present disclosure. FIG. 4(A) and FIG. 4(B) are schematic diagrams of IRO in topology as shown in FIG. 3.

As shown in FIG. 4(A), there are only sub-objects for AS in IRO. And as shown in FIG. 4(B), both AS (AS 100 and AS 200) are made of Area 0. Area is optional and it may be skipped.

So when the different domains only includes AS, the PCC acquires the domain sequence according to the IRO further includes: the PCC ignores the sub-object corresponding to an IGP area.

In another deployment scenario, there are only areas. Both end of LSP belong to different areas but within the same AS. This could be represented in domain sequence using the sub-object for area, and the sub-object for AS number may be skipped.

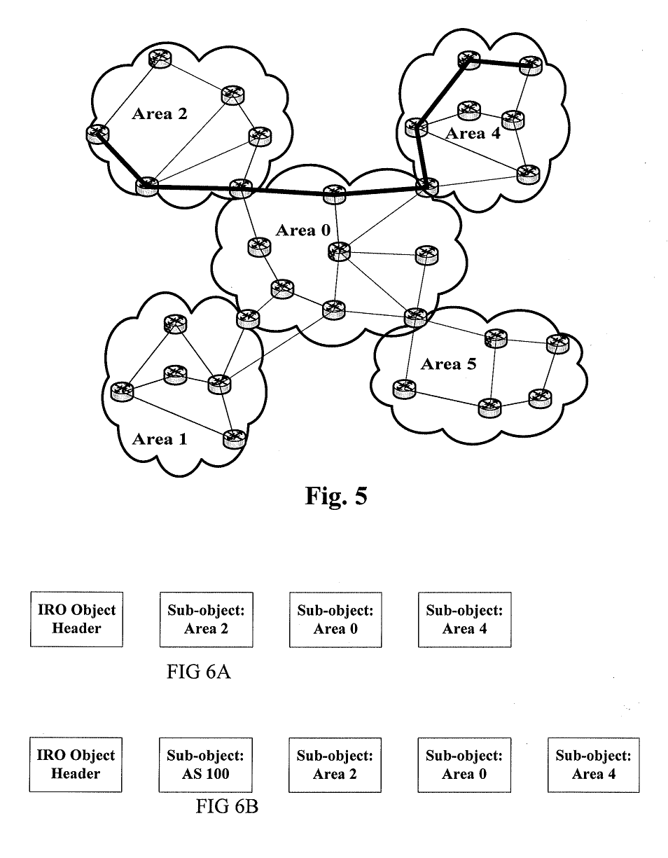

FIG. 5 is a topology diagram showing only area of an embodiment of the present disclosure. As shown in FIG. 5, communication process is among Area 2, Area 0 and Area 4.

FIG. 6(A) and FIG. 6(B) are schematic diagrams of IRO in topology as shown in FIG. 5. As shown in FIG. 6(A), there are only sub-objects for areas in IRO. And as shown in FIG. 6(B), AS number is 100. AS is optional and it may be skipped.

So when the different domains only including IGP area, the PCC acquires the domain sequence according to the IRO further includes: the PCC ignores the sub-object corresponding to an AS.

In another deployment scenario, there are mix of AS and area. In inter- AS case where an AS is further made up of multiple areas, both AS number and area should be a part of domain sequence.

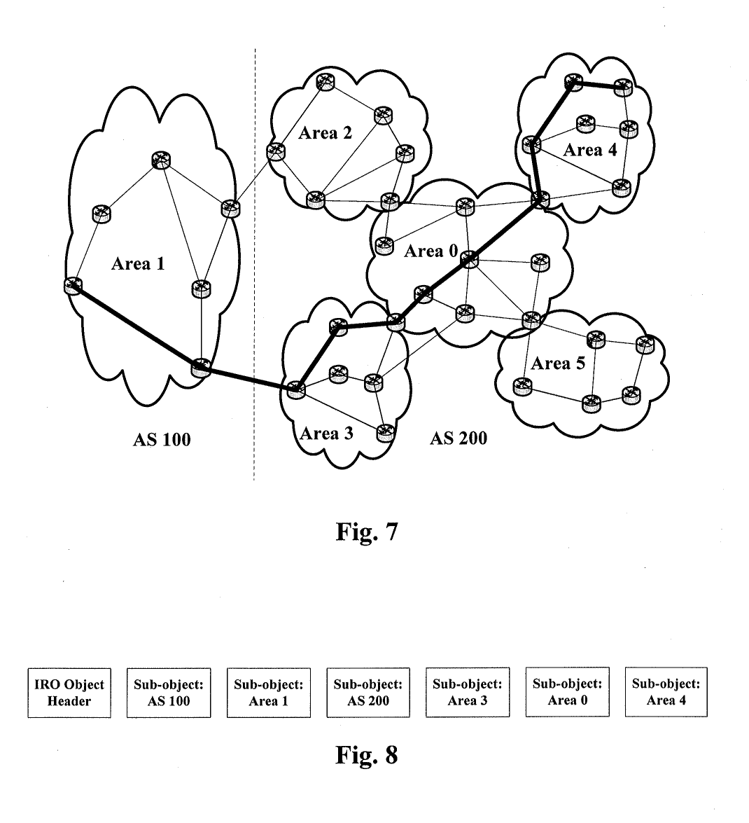

FIG. 7 is a topology diagram showing mix of AS and area of an embodiment of the present disclosure. As shown in FIG. 7, AS 100 includes Area 1, and AS 200 includes Area 2, Area 4, Area 0, Area 3 and Area 5. Communication process is among Area 1, Area 3, Area 0 and Area 4.

FIG. 8 is schematic diagram of IRO in topology as shown in FIG. 7. As shown in FIG. 8, the domain sequence can be carried in IRO, and combination of both AS and area uniquely identify a domain in the domain sequence.

In the present application, a single PCE may be responsible for multiple domains. for example, PCE function deployed on an IGP Area Border Router (ABR). Domain sequence should have no impact on this. PCE which can support 2 adjacent domains can internally handle this situation without any impact on the neighboring domains.

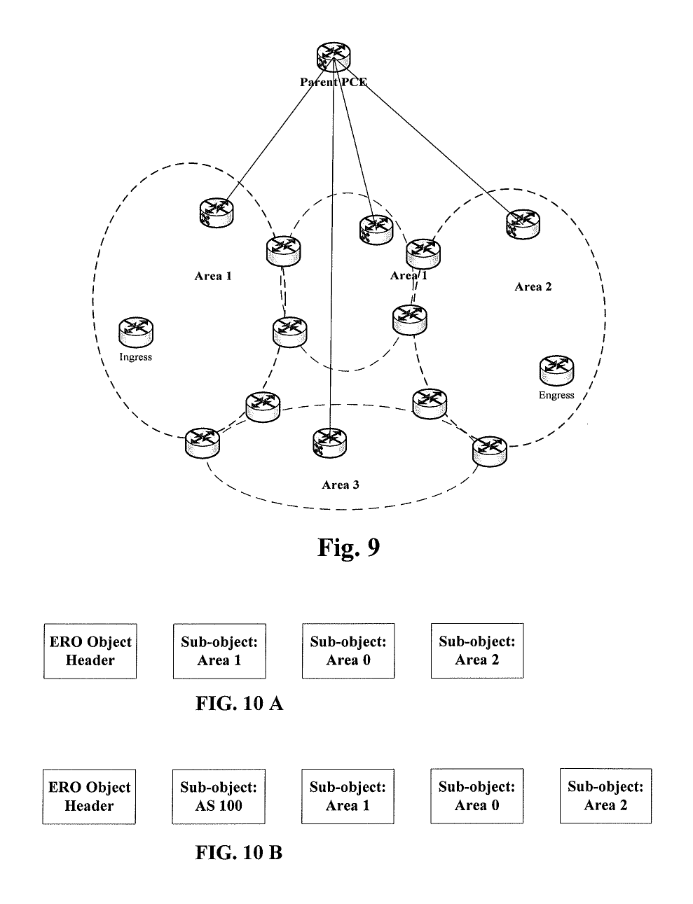

In another deployment scenario, there are child PCE and parent PCE. The case is a Hierarchy Path Computation Element (HPCE). FIG. 9 is a topology diagram showing HPCE of an embodiment of the present disclosure.

In HPCE implementation PCE can request the parent PCE to determine the domain path, and the parent PCE return in the PCRep message in form of Explicit Route Object (ERO). The sub-object would be for AS or for area (such as for OSPF, or for ISIS).

So if the PCE is a parent PCE, the method further includes: the PCC receives a PCRep message from the parent PCE, wherein the PCRep message includes an ERO. The ERO includes at least two sub-objects, and the at least two sub-objects are identified the different domains.

FIG. 10(A) and FIG. 10(B) are schematic diagrams of ERO in topology as shown in FIG. 9. As shown in FIG. 10(A), there are only sub-objects for area in ERO. And as shown in FIG. 10(B), AS number is 100. AS is optional and it may be skipped.

The embodiments of the present disclosure further provide a method of communicating across different domains, the method applied for a PCE.

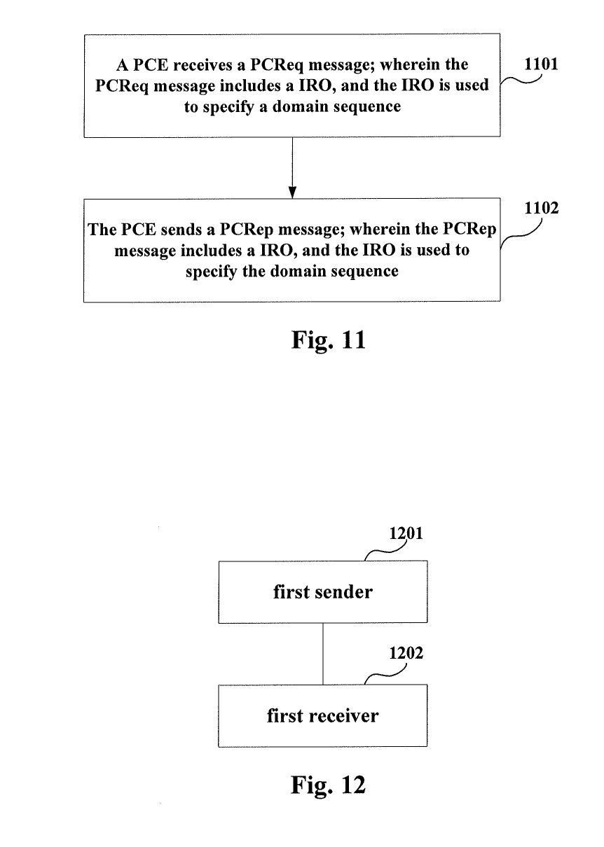

FIG. 11 is flowchart of the method of an embodiment of the present disclosure. As shown in FIG. 11, the method includes:
Step 1101, a PCE receives a PCReq message; wherein the PCReq message includes an IRO, the IRO is configured to specify a domain sequence;
wherein the IRO includes at least two sub-objects, and the at least two sub-objects are identified the different domains.

As shown in FIG. 11, the method may further include:
Step 1102, the PCE sends a PCRep message. wherein the PCRep message includes an IRO, the IRO is configured to specify the domain sequence.

In the present application, the PCE may receive the PCReq message from a PCC, or from another PCE. And the PCE may send the PCRep message to a PCC, or to another PCE.

Furthermore, wherein the sub-object includes an Area-Id. the Area-Id is a 32 bit number for OSPaF; or the Area-Id is of variable length for ISIS.

In an embodiment of the present disclosure, after received the PCReq message, the method further includes: the PCE acquires the domain sequence according to the IRO.

In a deployment scenario, the different domains only include AS, the PCE acquires the domain sequence according to the IRO further includes: the PCE ignores the sub-object corresponding to an IGP area.

In another deployment scenario, the different domains only include IGP area, the PCE acquires the domain sequence according to the IRO further includes: the PCE ignores the sub-object corresponding to an AS.

In another deployment scenario, the PCE is a parent PCE, the method further includes: the parent PCE sends a PCRep message; wherein the PCRep message includes an ERO.
wherein the ERO includes at least two sub-objects, and the at least two sub-objects are identified the different domains.

It can be seen from the above embodiments that standard way of representation for domain sequence has been implemented by using sub-object for area, and interoperability issues among different domains will be resolved.

The embodiments of the present disclosure further provide a network apparatus. In the present application, the network apparatus may be a PCC or a PCE.

FIG. 12 is a schematic diagram of the network apparatus of an embodiment of the present disclosure. As shown in FIG. 12, the network apparatus includes: a first sender 1201; wherein,
the first sender 1201 is configured to send a PCReq message to a PCE; wherein the PCReq message includes an IRO, the IRO is configured to specify a domain sequence;
wherein the IRO includes at least two sub-objects, and the at least two sub-objects are identified the different domains.

As shown in FIG. 12, the network apparatus may further include: a first receiver 1202; where the first receiver 1202 is used to receive a PCRep message from the PCE; wherein the PCRep message includes an IRO, the IRO is used to specify the domain sequence.

In the present application, the sub-object includes an Area-Id. wherein the Area-Id is a 32 bit number for OSPF; or the Area-Id is of variable length for ISIS.

In an embodiment of the present disclosure, the network apparatus may further include: a first acquirer (no shown). the first acquirer is used to acquire the domain sequence according to the IRO after the first receiver 1202 has received the PCRep message from the PCE.

In a deployment scenario, the said different domains only include AS, and the first acquirer is further used to ignore the sub-object corresponding to an IGP area.

In another deployment scenario, the said different domains only include IGP area, and the first acquirer is further used to ignore the sub-object corresponding to an AS.

In another deployment scenario, the PCE is a parent PCE, and the first receiver 1202 is further used to receive a PCRep message from the parent PCE; wherein the PCRep message includes an ERO;
wherein the ERO includes at least two sub-objects, and the at least two sub-objects are identified the different domains.

The embodiments of the present disclosure further provide a network apparatus. In the present application, the network apparatus may be a PCE.

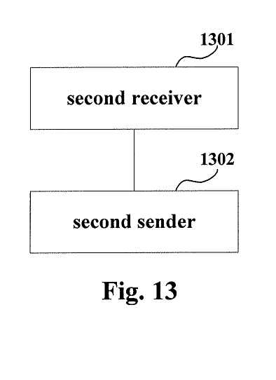

FIG. 13 is a schematic diagram of the network apparatus of another embodiment of the present disclosure. As shown in FIG. 13, the network apparatus includes: a second receiver 1301; wherein,
the second receiver 1301 is used to receive a PCReq message; wherein the PCReq message includes an IRO, the IRO is used to specify a domain sequence;
wherein the IRO includes at least two sub-objects, and the at least two sub-objects are identified the different domains.

As shown in FIG. 13, the network apparatus may further include: a second sender 1302; wherein,
the second sender 1302 is used to send a PCRep message; wherein the PCRep message includes an IRO, the IRO is used to specify the domain sequence.

In the present application, the sub-object includes an Area-Id. and the Area-Id is a 32 bit number for OSPF; or the Area-Id is of variable length for ISIS.

In an embodiment of the present disclosure, the network apparatus may further include: a second acquirer (no shown). the second acquirer is used to acquire the domain sequence according to the IRO after the second receiver 1301 has received the PCReq message.

In another deployment scenario, the said different domains only include AS, and the second acquirer is further used to ignore the sub-object corresponding to an Interior Gateway Protocol area.

In another deployment scenario, the said different domains only include IGP area, and the second acquirer is further used to ignore the sub-object corresponding to an AS.

In another deployment scenario, the PCE is a parent PCE, and the second sender 1302 is further used to send a PCRep message; wherein the PCRep message includes an ERO;
wherein the ERO includes at least two sub-objects, and the at least two sub-objects are identified the different domains.

It can be seen from the above embodiments that standard way of representation for domain sequence has been implemented by using sub-object for area, and interoperability issues among different domains will be resolved.

The embodiments of the present disclosure further provide a computer-readable program, wherein when the program is executed in a network apparatus; the program enables the computer to carry out the method of communicating across different domains.

The embodiments of the present disclosure further provide a storage medium in which a computer-readable program is stored, wherein the computer-readable program enables the computer to carry out the method of communicating across different domains.

It should be understood that each of the parts of the present disclosure may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a hardware processor, or other systems capable of extracting instructions from an instruction executing system, device or apparatus and executing the instructions), or for use in combination with the instruction executing system, device or apparatus.

The above literal description and drawings show various features of the present disclosure. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present disclosure by using the apparatus.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A method of communicating across different domains, comprising:
sending a Path Computation Request message to a Path Computation Element, wherein the Path Computation Request message comprises an Include Route Object, and the Include Route Object is configured to specify a domain sequence;
wherein the Include Route Object comprises at least two sub-objects, and the at least two sub-objects identify the different domains.

2. The method according to claim 1, further comprising:
receiving a Path Computation Reply message from the Path Computation Element, wherein the Path Computation Reply message comprises an Include Route Object, and the Include Route Object is configured to specify the domain sequence.

3. The method according to claim 1, wherein the sub-object comprises an Area-Id;
wherein the Area-Id is a 32 bit number for Open Shortest Path First; or the Area-Id is of variable length for Intermediate System-Intermediate System.

4. The method according to claim 2, after receiving the Path Computation Reply message from the Path Computation Element, the method further comprising:
acquiring the domain sequence according to the Include Route Object.

5. The method according to claim 1, wherein the Path Computation Element comprises a parent Path Computation Element, the method further comprising:
receiving a Path Computation Reply message from the parent Path Computation Element, wherein the Path Computation Reply message comprises an Explicit Route Object;
wherein the Explicit Route Object comprises at least two sub-objects, and the at least two sub-objects identify the different domains.

6. A method of communicating across different domains, comprising:
receiving a Path Computation Request message, wherein the Path Computation Request message comprises an Include Route Object, and the Include Route Object is configured to specify a domain sequence;
wherein the Include Route Object comprises at least two sub-objects, and the at least two sub-objects identify the different domains.

7. The method according to claim 6, further comprising:
sending a Path Computation Reply message; wherein the Path Computation Reply message comprises an Include Route Object, and the Include Route Object is configured to specify the domain sequence.

8. The method according to claim 6, wherein the sub-object comprises an Area-Id;
wherein the Area-Id is a 32 bit number for Open Shortest Path First; or the Area-Id is of variable length for Intermediate System-Intermediate System.

9. The method according to claim 6, after receiving the Path Computation Request message, the method further comprising:
acquiring the domain sequence according to the Include Route Object.

10. The method according to claim 6, wherein the Path Computation Element comprises a parent Path Computation Element, the method further comprising:
sending a Path Computation Reply message, wherein the Path Computation Reply message comprises an Explicit Route Object;
wherein the Explicit Route Object comprises at least two sub-objects, and the at least two sub-objects identify the different domains.

11. A network apparatus, comprising:
a first sender, configured to send a Path Computation Request message to a Path Computation Element, wherein the Path Computation Request message comprises an Include Route Object, and the Include Route Object is configured to specify a domain sequence;
wherein the Include Route Object comprises at least two sub-objects, and the at least two sub-objects identify the different domains.

12. The network apparatus according to claim 11, further comprising:
a first receiver, configured to receive a Path Computation Reply message from the Path Computation Element, wherein the Path Computation Reply message comprises an Include Route Object, and the Include Route Object is configured to specify the domain sequence.

13. The network apparatus according to claim 12, further comprising:
a first acquirer, configured to acquire the domain sequence according to the Include Route Object after the first receiver has received the Path Computation Reply message from the Path Computation Element.

14. The network apparatus according to claim 12, wherein the Path Computation Element comprises a parent Path Computation Element,
and the first receiver is further configured to receive a Path Computation Reply message from the parent Path Computation Element, wherein the Path Computation Reply message comprises an Explicit Route Object;
wherein the Explicit Route Object comprises at least two sub-objects, and the at least two sub-objects identify the different domains.

15. The network apparatus according to claim 11, wherein the network apparatus comprises a Path Computation Client or a Path Computation Element.

16. A network apparatus, comprising:
a second receiver, configured to receive a Path Computation Request message, wherein the Path Computation Request message comprises an Include Route Object, and the include Route Object is configured to specify a domain sequence;
wherein the Include Route Object comprises at least two sub-objects, and the at least two sub-objects identify the different domains.

17. The network apparatus according to claim 16, further comprising:
a second sender, configured to send a Path Computation Reply message, wherein the Path Computation Reply message comprises an Include Route Object, and the Include Route Object is configured to specify the domain sequence.

18. The network apparatus according to claim 16, further comprising:
a second acquirer, configured to acquire the domain sequence according to the Include Route Object after the second receiver has received the Path Computation Request message.

19. The network apparatus according to claim 17, wherein the Path Computation Element comprises a parent Path Computation Element,
the second sender is further configured to send a Path Computation Reply message; wherein the Path Computation Reply message comprises an Explicit Route Object;
wherein the Explicit Route Object comprises at least two sub-objects, and the at least two sub-objects identify the different domains.

20. The network apparatus according to claim 16, wherein the network apparatus comprises a Path Computation Element.
